(19) United States
(12) Patent Application Publication
(10) Pub. No.: US 2010/0040304 A1
(43) Pub. Date: Feb. 18, 2010

(54) IMAGE QUALITY IMPROVEMENT PROCESSING APPARATUS, IMAGE QUALITY IMPROVEMENT PROCESSING METHOD AND COMPUTER-READABLE RECORDING MEDIUM STORING IMAGE QUALITY IMPROVEMENT PROCESSING COMPUTER PROGRAM

(75) Inventors: Masatoshi OKUTOMI, Tokyo (JP); Masayuki TANAKA, Tokyo (JP); Yoichi YAGUCHI, Tokyo (JP); Soonkeun CHANG, Tokyo (JP); Masao SHIMIZU, Tokyo (JP)

Correspondence Address: NIXON PEABODY, LLP, 401 9TH STREET, NW, SUITE 900, WASHINGTON, DC, 20004-2128, US

(73) Assignees: TOKYO INSTITUTE OF TECHNOLOGY, Tokyo (JP); OLYMPUS CORPORATION, Tokyo (JP)

(21) Appl. No.: 12/543,191

(22) Filed: Aug. 18, 2009

Related U.S. Application Data
(63) Continuation-in-part of application No. PCT/JP2008/053124, filed on Feb. 19, 2008.

(30) Foreign Application Priority Data
Feb. 19, 2007 (JP) 2007-038006

(51) Int. Cl. G06K 9/40

(52) U.S. Cl. 382/264; 382/274; 382/254

(57) ABSTRACT

The present invention provides an image quality improvement processing apparatus that removes occlusion regions and regions that the registration error is large, selects pixels suitable for the image quality improvement processing, and generates an image with high image quality.

The image quality improvement processing apparatus of the present invention comprises a means that performs the registration processing between a basis image and an input image and generates a basis image that registration processing is already performed, a means that selects pixels used in an image quality improvement processing based on the basis image that registration processing is already performed and the input image by a predetermined condition and generates an input image that pixel selection is performed by performing an image synthesis based on a pixel selection result and the input image, a means that amends pixel values of the input image that pixel selection is performed so that luminances of pixels of the input image that pixel selection is performed become equal to luminances of corresponding pixels of the basis image that registration processing is already performed and generates an input image that pixel selection and luminance amendment are performed, and a means that performs the image quality improvement processing based on the input image that pixel selection and luminance amendment are performed and generates the image with high image quality.

### TECHNICAL FIELD

The present invention relates to image processing technologies, more particularly, to an image quality improvement processing apparatus, an image quality improvement processing method and a computer-readable recording medium storing an image quality improvement processing computer program that use a pixel selection processing and a luminance amendment processing and then generate an image with high image quality based on pixels that pixel selection and luminance amendment are performed.

### BACKGROUND TECHNIQUE

In image processing technologies, there is the image quality improvement processing that generates an image with high image quality by using multiple input images. “The super-resolution processing” is one of such an image quality improvement processing.

The super-resolution processing is a processing that estimates (reconstructs) one high-resolution image by using multiple low-resolution images having displacements, more specifically, consists of “a registration processing” that registers multiple low-resolution images having displacements and “a high-resolution-ization processing” that generates (estimates) a high-resolution image based on pixels of multiple low-resolution images after registration.

In such a super-resolution processing, in order to obtain a desired image with high image quality, the high accuracy registration between low-resolution images is very important, that is to say, in the super-resolution processing, the high accuracy registration processing is demanded.

However, in general, since the registration processing between images is difficult, things such as a thing that big errors are included in the processing result and a thing that the registration processing failed, often happen.

In the super-resolution processing, if the accuracy of the registration processing is low, the result of the super-resolution processing (the obtained high-resolution image) degrades greatly. Further, in the case that a region of interest that is set on a basis image (i.e. a region that wants to be high-resolution-ized) is occluded, that is to say, in the case that an occlusion region exists, similarly, the result of the super-resolution processing degrades greatly.

In addition, in accordance with occlusions, shadows often occur. In this case, even if the registration processing is precisely performed, shadows due to occlusions will become the cause that degrades the result of the super-resolution processing.

Conventionally, in the super-resolution processing, for example, as disclosed in Non-Patent Document 1, there is a pixel selection method that selects pixels used in the high-resolution-ization processing (hereinafter simply referred to as “pixels”) based on a cross correlation of surrounding regions of corresponding pixels between a basis image and an input image. That is to say, the pixel selection method disclosed in Non-Patent Document 1, is a pixel selection method that only depends on a similarity based on a cross correlation.

Further, for example, as disclosed in Non-Patent Document 2, there is a pixel selection method that selects pixels based on differences between pixel values of a basis image and pixel values of an input image. That is to say, the pixel selection method disclosed in Non-Patent Document 2, is a pixel selection method that only depends on a similarity based on simple luminance differences.

Moreover, in Non-Patent Document 3, a method that determines a degree of importance for every block based on the luminance value difference for every block, the displacement and the frame distance between a basis image and an input image, is disclosed. That is to say, the method disclosed in Non-Patent Document 3, is a method that considers the displacement and the frame distance in a similarity based on the luminance difference for every block.

In addition, in the case that an occlusion region exists, there is “an image registration method” that performs the registration processing with a high degree of accuracy after considering the occlusion region as disclosed in Japanese Patent Application Number 2006-080784 and Non-Patent Document 4.

### DISCLOSURE OF THE INVENTION

An aspect of the present invention is an image quality improvement processing apparatus for generating an image with high image quality based on a basis image and one or more input images, said apparatus characterized by comprising: a registration processing unit for generating a basis image that registration processing is already performed by performing a registration processing between said basis image and said input image; a pixel selection processing unit for selecting pixels used in an image quality improvement processing based on said basis image that registration processing is already performed generated in said registration processing unit and said input image by a predetermined condition, and generating an input image that pixel selection is performed by performing an image synthesis based on a pixel selection result and said input image; and an image quality improvement processing unit for generating said image with high image quality by performing said image quality improvement processing based on said input image that pixel selection is performed generated in said pixel selection processing unit.

Further, an aspect of the present invention is an image quality improvement processing apparatus for generating an image with high image quality based on a basis image and one or more input images, said apparatus characterized by comprising: a registration processing unit for generating a basis image that registration processing is already performed by performing a registration processing between said basis image and said input image; a luminance amendment processing unit for generating an input image that luminance amendment is performed by amending pixel values of said input image so that luminances of pixels of said input image become equal to luminances of corresponding pixels of said basis image that registration processing is already performed; and an image quality improvement processing unit for generating said image with high image quality by performing an image quality improvement processing based on said input image that luminance amendment is performed generated in said luminance amendment processing unit.

Moreover, an aspect of the present invention is an image quality improvement processing apparatus for generating an image with high image quality based on a basis image and one or more input images, said apparatus characterized by comprising: a basis image preprocessing and registration processing unit for generating a basis image that deformation preprocessing is already performed by performing a registration processing between a basis image that preprocessing is already performed obtained by performing a basis image preprocessing for said basis image and said input image; an input image preprocessing and pixel selection processing unit for selecting pixels used in an image quality improvement processing based on said basis image that deformation preprocessing is already performed and an input image that preprocessing is already performed obtained by performing an input image preprocessing for said input image by a predetermined condition, and generating an input image that pixel selection is performed by performing an image synthesis based on a pixel selection result and said input image; a luminance amendment processing unit for generating an input image that pixel selection and luminance amendment are performed by amending pixel values of said input image that pixel selection is performed so that luminances of pixels of said input image that pixel selection is performed become equal to luminances of corresponding pixels of said basis image that deformation preprocessing is already performed; and an image quality improvement processing unit for generating said image with high image quality by performing said image quality improvement processing based on said input image that pixel selection and luminance amendment are performed.

### BRIEF DESCRIPTION OF THE DRAWINGS

FIG. 1 is a block constitution diagram illustrating a first embodiment of an image quality improvement processing apparatus according to the present invention;

FIG. 2 is a conceptual diagram illustrating “a registration processing” that is performed in a registration processing unit of the present invention and “a pixel selection processing” that is performed in a pixel selection processing unit of the present invention;

FIG. 3 is a conceptual diagram illustrating “a luminance amendment processing” that is performed in a luminance amendment processing unit of the present invention;

FIG. 4 is a block constitution diagram illustrating a second embodiment of an image quality improvement processing apparatus according to the present invention;

FIG. 5 is a block constitution diagram illustrating a third embodiment of an image quality improvement processing apparatus according to the present invention;

FIG. 6 is a block constitution diagram illustrating a fourth embodiment of an image quality improvement processing apparatus according to the present invention;

FIG. 7 is a block constitution diagram illustrating a fifth embodiment of an image quality improvement processing apparatus according to the present invention;

FIG. 8 is a conceptual diagram illustrating “a registration processing” that is performed in a basis image preprocessing and registration processing unit of the present invention and “a pixel selection processing” that is performed in an input image preprocessing and pixel selection processing unit of the present invention;

FIG. 9 is a block constitution diagram illustrating a sixth embodiment of an image quality improvement processing apparatus according to the present invention; and

FIG. 10 shows an image processing result based on a conventional method and an image processing result based on the present invention, FIG. 10(A) shows a basis image, FIG. 10(B) shows the high-resolution-ization processing result based on a conventional super-resolution processing method, FIG. 10(C) shows the high-resolution-ization processing result based on “the image quality improvement processing apparatus” according to the first embodiment of the present invention.

### DESCRIPTION OF THE NUMERALS

1, 2, 3, 4, 5, 6 image quality improvement processing apparatus registration processing unit
11 basis image preprocessing and registration processing unit
20 pixel selection processing unit
21 input image preprocessing and pixel selection processing unit
30 luminance amendment processing unit
35 pixel position amendment processing unit
40 image quality improvement processing unit

### THE BEST MODE FOR CARRYING OUT THE INVENTION

At first, we describe the point aimed at of the present invention.

Firstly, in the super-resolution processing, it is assumed that a basis image which is a low-resolution image and input images are already registered by any method (for example, a conventional registration method). The registration in the case that an occlusion region exists, for example, can use “the image registration method” disclosed in Non-Patent Document 4 and Japanese Patent Application Number 2006-080784.

In this case, we consider surrounding small regions (hereinafter simply referred to as “small regions”) of corresponding pixels between a basis image and an input image (hereinafter simply referred to as “pixels of interest”).

In the case that a similarity of corresponding small regions between the basis image and the input image is high and the displacement is re-estimated by using either small region, if the value of the estimated displacement is small, it is possible to consider that corresponding pixels are pixels that accurately correspond to each other.

That is to say, the condition that the pixel of interest is selected as a pixel suitable for the image quality improvement processing (in the case that the image quality improvement processing is the super-resolution processing, becoming the high-resolution-ization processing), is a thing (1) that the similarity of corresponding small regions between the basis image and the input image is high and a thing (2) that the estimated value of the displacement which uses either small region is small.

Next, we consider luminance variations. We consider that the luminance amendment processing is performed before performing the pixel selection processing or after performing the pixel selection processing.

Therefore, it is desirable to perform the pixel selection processing by a method that does not depend on luminance variations. Because after the pixel selection processing, by performing the luminance amendment processing for pixels that pixel selection is performed, pixels that only the luminance varies become available for the image quality improvement processing.

As a result, the present invention focuses attention on a thing that a similarity that does not depend on luminance variations is used as the similarity used in the case of the pixel selection processing and a displacement estimating method that does not depend on luminance variations is used in estimating the displacement used in the case of the pixel selection processing.

The following is a description of preferred embodiments for carrying out the present invention, with reference to the accompanying drawings.

The present invention relates to an image quality improvement processing apparatus, an image quality improvement processing method and a computer-readable recording medium storing an image quality improvement processing computer program that perform one or more image processing of “a pixel selection processing (or an input image preprocessing and a pixel selection processing)”, “a luminance amendment processing” and “a pixel position amendment processing” after performing “a registration processing (or a basis image preprocessing and a registration processing)” between a basis image and an input image based on one basis image and one or more input images (an input image sequence), and then generate an image with high image quality by performing “an image quality improvement processing” based on pixels selected as a result that the said one or more image processing are performed.

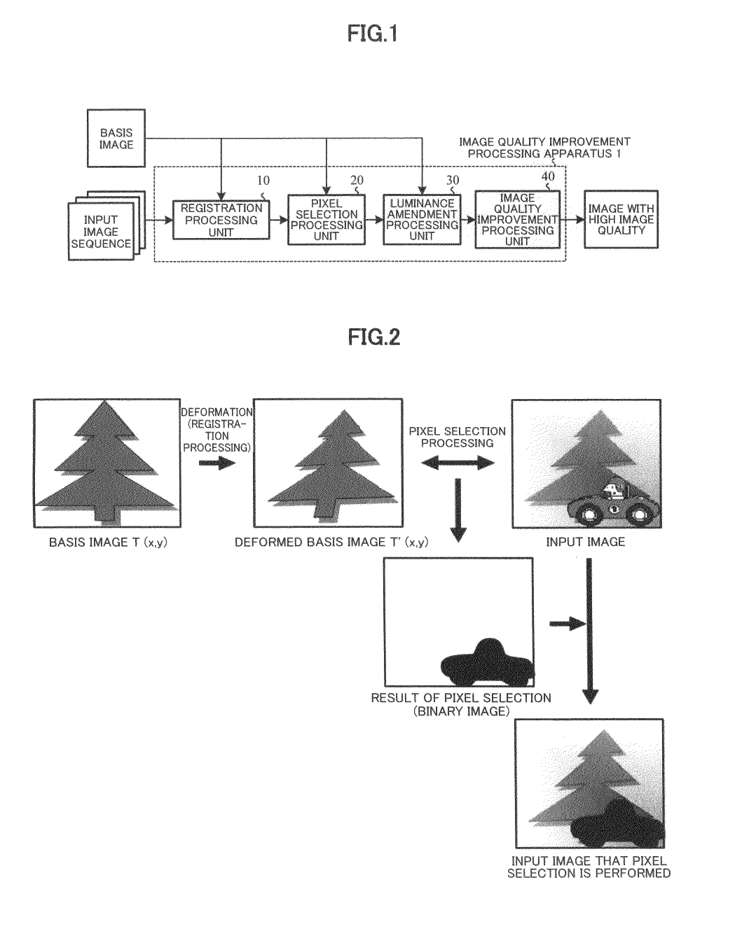

FIG. 1 is a block constitution diagram illustrating a first embodiment of an image quality improvement processing apparatus according to the present invention.

As shown in FIG. 1, “the image quality improvement processing apparatus” according to the first embodiment of the present invention (hereinafter also simply referred to as “an image quality improvement processing apparatus 1”) comprises a registration processing unit 10, a pixel selection processing unit 20, a luminance amendment processing unit 30 and an image quality improvement processing unit 40.

In the image quality improvement processing apparatus 1 of the present invention, at first, the registration processing unit 10 performs “the registration processing” between the basis image and the input image based on the basis image and the input images (the input image sequence). Next, the pixel selection processing unit 20 performs “the pixel selection processing” that selects pixels suitable for the image quality improvement processing based on the basis image after the registration processing and the input image. And then, the luminance amendment processing unit 30 performs “the luminance amendment processing” that performs the luminance amendment for pixels of the input image that pixel selection is performed so that luminances of pixels of the said input image become corresponding to luminances of corresponding pixels of the basis image. Finally, the image quality improvement processing unit 40 generates an image with high image quality by performing “the image quality improvement processing” based on pixels that pixel selection and luminance amendment are performed.

In the present invention, “the registration processing” performed in the registration processing unit 10 and “the image quality improvement processing” performed in the image quality improvement processing unit 40 use existing methods.

For example, in the case that the image quality improvement processing is the super-resolution processing, “the image quality improvement processing” performed in the image quality improvement processing unit 40, becomes the high-resolution-ization processing. And then, in “the image quality improvement processing” performed in the image quality improvement processing unit 40, in addition to the high-resolution-ization processing, it is possible to use a processing such as a noise removal processing and a wide dynamic range image processing.

Here, at first, we describe “the registration processing” performed in the registration processing unit 10 and “the pixel selection processing” performed in the pixel selection processing unit 20.

For convenience of explanation, we describe the case that the basis image and the input images (the input image sequence) are grayscale images or color images.

In addition, in the case that the basis image and the input images are color mosaic images, that is to say, in the case of generating a high-resolution image from color mosaic images, the color mosaic images are restored to color images once, and then, if the present invention is applied by using the restored color images, it is possible to obtain a desired image with high image quality.

FIG. 2 is a conceptual diagram illustrating “the registration processing” that is performed in the registration processing unit 10 of the present invention and “the pixel selection processing” that is performed in the pixel selection processing unit 20 of the present invention.

As shown in FIG. 2, firstly, the registration processing unit 10 generates a deformed basis image T′(x,y) by performing a registration processing (a deformation) based on the k-th input image Iₖ(x,y) of the input image sequence (not shown in FIG. 2) and the basis image T(x,y), that is to say, by deforming the basis image T(x,y) so that the basis image T(x,y) comes to correspond to the k-th input image Iₖ(x,y) (hereinafter simply referred to as “the input image”).

In other words, the registration processing unit 10 generates (obtains) the deformed basis image by performing the registration processing between the basis image and the input image. Incidentally, as described above, the registration processing (the deformation processing) uses an existing method.

However, in the present invention, it is not always true that the deformation of the basis image for the input image is complete, that is to say, it is not necessarily the case that the registration processing between the basis image and the input image performed in the registration processing unit 10 is performed precisely, and there is the case that the registration result includes registration errors or occlusions (occlusion regions) exist.

Next, we concretely describe “the pixel selection processing” performed in the pixel selection processing unit 20 after the registration processing (the deformation) is performed. “The pixel selection processing” performed in the pixel selection processing unit 20 is a processing that selects pixels used in “the image quality improvement processing” performed in the image quality improvement processing unit 40, i.e. pixels suitable for the image quality improvement processing.

Here, we describe the case of performing the pixel selection processing with respect to a pixel of a certain position (x,y) of the input image (hereinafter also simply referred to as “a pixel of interest) in the pixel selection processing unit 20.

That is to say, in the pixel selection processing unit 20, with respect to a surrounding small region of a pixel of interest, in the case that the following two conditions are satisfied, the pixel of interest is selected as “a pixel used in the image quality improvement processing”.

### Condition 1:

A similarity of a small region of the input image including the pixel of interest and a corresponding small region of the basis image that registration processing is already performed obtained by the registration processing between the input image and the basis image (in the case of FIG. 2, the deformed basis image T′(x,y) obtained by deforming the basis image to the input image), is a predetermined threshold (hereinafter also simply referred to as the first threshold) or more.

### Condition 2:

An estimated value of a displacement of the pixel of interest which uses either the small region of the input image or the corresponding small region of the basis image that registration processing is already performed (the deformed basis image), is a predetermined threshold (hereinafter also simply referred to as the second threshold) or less.

The pixel selection processing unit 20 generates a binary format image shown in FIG. 2 (a pixel selection result) that corresponds to the input image by setting the pixel of interest that satisfies the above condition 1 and condition 2 as a pixel value 1 and setting the pixel of interest that does not satisfy the above condition 1 and condition 2 as a pixel value 0, that is to say, selects pixels used in the image quality improvement processing.

In the pixel selection processing unit 20, specifically, in the binary format image (the pixel selection result) of FIG. 2, pixel values of pixels of the white part are 1 and the said pixels are selected as pixels used in the image quality improvement processing, further, pixel values of pixels of the black part are 0 and the said pixels are not selected as pixels used in the image quality improvement processing. In other words, the pixels of the black part are pixels that are removed by “the pixel selection processing” of the present invention. It is possible to regard the binary format image of FIG. 2 as a mask image.

Moreover, in the pixel selection processing unit 20, if necessary, it is also possible to perform the selection of pixels used in the image quality improvement processing by performing a low-pass filtering for the binary format image of FIG. 2 and performing a binarizing processing using a proper threshold.

In short, the pixel selection processing unit 20 performs the pixel selection by selecting the pixel of interest that satisfies the above condition 1 and condition 2 as a pixel used in the image quality improvement processing and removing the pixel of interest that does not satisfy the above condition 1 and condition 2, and then generates “an input image that pixel selection is performed” shown in FIG. 2 by performing an image synthesis (a mask synthesis) based on the binary format image that is the pixel selection result (pixels with the pixel value 1 means pixels used in the image quality improvement processing and pixels with the pixel value 0 means pixels that are not used in the image quality improvement processing, i.e. pixels that are removed) and the input image.

In addition, although the pixel selection processing unit 20 described above, performs the pixel selection by determining whether condition 1 and condition 2 are satisfied or not based on a threshold determination processing, that is to say, by using a binary mask as the pixel selection mask, the present invention is not be limited to using a binary mask. In the present invention, it is also possible to perform the pixel selection by using a multi-value mask (a weight). In short, both condition 1 and condition 2 generate a multi-value mask (a weight) as the pixel selection mask based on the similarity or the estimated value of the displacement (the displacement) without performing a threshold processing.

Specifically, in condition 1, if the similarity of a small region of the input image including the pixel of interest and a corresponding small region of “the basis image that registration processing is already performed” obtained by the registration processing between the input image and the basis image, becomes large, the value of the first multi-value mask (the first weight) is set to become large. Further, in condition 2, the displacement of the pixel of interest which uses either the small region of the input image or the corresponding small region of the basis image that registration processing is already performed (the deformed basis image), becomes small, the value of the second multi-value mask (the second weight) is set to become large.

In this way, condition 1 and condition 2 generate values of multi-value masks, i.e. the first weight and the second weight from the similarity and the displacement, respectively. The obtained the first weight and the second weight are synthesized by a proper operation (for example, a multiplication). A multi-value image (the pixel selection result) is obtained by the synthesized weight (the multi-value mask). If necessary, it is also possible to perform the selection of pixels used in the image quality improvement processing by performing a low-pass filtering for the multi-value image and performing a binarizing processing using a proper threshold. In the image quality improvement processing, it is possible to use the multi-value mask of the pixel of interest as the degree of importance (the weight) of the pixel of interest.

Furthermore, in the embodiment of “the pixel selection processing unit 20” of the present invention described above, although satisfying the above condition 1 and condition 2 is set as the condition of the pixel selection, “the pixel selection processing unit 20” of the present invention is not be limited to that. In “the pixel selection processing unit 20” of the present invention, it is also possible to select the pixel of interest that satisfies only the above condition 1 or the pixel of interest that satisfies only the above condition 2 as the pixel used in the image quality improvement processing.

Next, we describe “the luminance amendment processing” performed in the luminance amendment processing unit 30.

“The luminance amendment processing” performed in the luminance amendment processing unit 30 is a processing that amends the pixel value of the pixel of interest of the input image in the luminance amendment processing so that the luminance of the pixel of interest of the input image in the luminance amendment processing becomes equal to the luminance of corresponding pixel of “the basis image that registration processing is already performed (i.e. the deformed basis image)”.

Incidentally, in the luminance amendment processing unit 30 of the image quality improvement processing apparatus 1 shown in FIG. 1, the input image in the luminance amendment processing is “the input image that pixel selection is performed” generated by “the pixel selection processing” performed in “the pixel selection processing unit 20”.

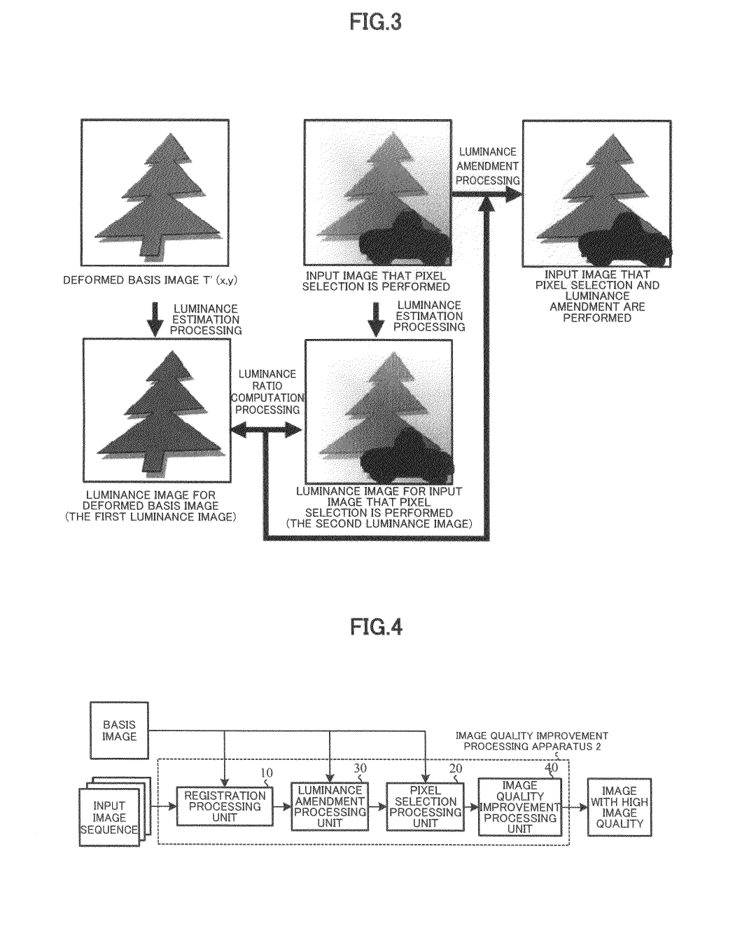

FIG. 3 is a conceptual diagram illustrating “the luminance amendment processing” that is performed in the luminance amendment processing unit 30 of the present invention.

“The luminance amendment processing” performed in the luminance amendment processing unit 30 shown in FIG. 3, is “a luminance amendment processing” that is performed after “the pixel selection processing” by “the pixel selection processing unit 20” is performed, that is to say, is “a luminance amendment processing” performed in the luminance amendment processing unit 30 of the image quality improvement processing apparatus 1 shown in FIG. 1. The input image in “the luminance amendment processing” of FIG. 3, means “the input image that pixel selection is performed” generated by “the pixel selection processing”.

As shown in FIG. 3, the luminance amendment processing unit 30 estimates the luminance of the pixel of interest of “the input image that pixel selection is performed” and the luminance of the corresponding pixel of the deformed basis image T′(x,y) by “the luminance estimation processing”respectively, and then generates a luminance image for deformed basis image (the first luminance image) and a luminance image for input image that pixel selection is performed (the second luminance image) based on the estimated luminances.

Then, the luminance amendment processing unit 30 computes a luminance ration of two sides based on the generated first luminance image and the generated second luminance image, and then generates “an input image that pixel selection and luminance amendment are performed” by performing “the luminance amendment processing” that amends the pixel value of the pixel of interest of “the input image that pixel selection is performed” so that the luminance of the pixel of interest of “the input image that pixel selection is performed” becomes equal to the luminance of the corresponding pixel of the deformed basis image.

Here, as a concrete example of a method that estimates the luminance of the pixel of interest, there is a method that obtains the luminance for every pixel of a small region including a pixel of interest and then estimates an averaged luminance obtained by averaging the obtained luminances or a weighted averaged luminance obtained by weighted-averaging the obtained luminances as the luminance of the pixel of interest. It is also possible to estimate the luminance of the corresponding pixel of the deformed basis image by the same method.

Further, as an obtaining method of the luminance for every pixel, for example, there is a method that uses I of the HSI(hue/saturation/intensity) color space of a six-sided pyramid model. I of the HSI color space of the six-sided pyramid model becomes a maximum value of the pixel value of R channel, G channel or B channel (see Non-Patent Document 5).

The above described “the pixel selection processing” performed in the pixel selection processing unit 20 of the present invention and “the luminance amendment processing” performed in the luminance amendment processing unit 30 of the present invention in detail.

The image quality improvement processing unit 40 of the image quality improvement processing apparatus 1 shown in FIG. 1, generates an image with high image quality by performing the image quality improvement processing based on “the input image that pixel selection and luminance amendment are performed” generated in the luminance amendment processing unit 30. Incidentally, as described above, the image quality improvement processing uses an existing method.

Further, since the image processing by the image quality improvement processing apparatus 1 shown in FIG. 1, has a flow that the luminance amendment processing by the luminance amendment processing unit 30 is performed after the pixel selection processing by the pixel selection processing unit 20, a pixel selection method that is robust for luminance variations is used in the pixel selection processing by the pixel selection processing unit 20. In short, it is preferable that the similarity of the above condition 1 uses a similarity which does not depend on luminance variations and the estimated value of the displacement of the above condition 2 is estimated by a displacement estimating method which does not depend on luminance variations.

As a concrete preferred example of the similarity that does not depend on luminance variations, for example, a normalized cross correlation of corresponding small regions is pointed to. Further, as a concrete preferred example of the displacement estimating method that does not depend on luminance variations, for example, a displacement estimating method that uses a parabola fitting of a normalized cross correlation of the displacement with pixel accuracy which assumed a translation, is pointed to.

FIG. 4 is a block constitution diagram illustrating a second embodiment of an image quality improvement processing apparatus according to the present invention.

As shown in FIG. 4, “the image quality improvement processing apparatus” according to the second embodiment of the present invention (hereinafter also simply referred to as “an image quality improvement processing apparatus 2”) comprises a registration processing unit 10, a luminance amendment processing unit 30, a pixel selection processing unit 20 and an image quality improvement processing unit 40.

Although the image processing by the image quality improvement processing apparatus 1 shown in FIG. 1, has a flow that “the luminance amendment processing” by the luminance amendment processing unit 30 is performed after “the pixel selection processing” by the pixel selection processing unit 20 is performed, the image processing by the present invention is not limited to that. Like the image quality improvement processing apparatus 2 shown in FIG. 4, it is also possible to perform “the pixel selection processing” by the pixel selection processing unit 20 after “the luminance amendment processing” by the luminance amendment processing unit 30 is performed.

In short, like “the registration processing” by the registration processing unit 10 of the image quality improvement processing apparatus 1 shown in FIG. 1, “the registration processing” performed in the registration processing unit 10 of the image quality improvement processing apparatus 2 shown in FIG. 4, uses an existing method.

Further, in “the luminance amendment processing” performed in the luminance amendment processing unit 30 of the image quality improvement processing apparatus 2 shown in FIG. 4, “the input images (the input image sequence)” that is also the input of the registration processing unit 10 of the image quality improvement processing apparatus 2, is set as “the input image in the luminance amendment processing”. An image generated by “the luminance amendment processing” performed in the luminance amendment processing unit 30 of the image quality improvement processing apparatus 2 shown in FIG. 4, becomes “an input image that luminance amendment is performed”.

Moreover, in the pixel selection processing unit 20 of the image quality improvement processing apparatus 2 shown in FIG. 4, “the input image that luminance amendment is performed” generated by “the luminance amendment processing” performed in the luminance amendment processing unit 30 of the image quality improvement processing apparatus 2 shown in FIG. 4, is set as “the input image” in the above condition 1 and condition 2, that is to say, “the input image that luminance amendment is performed” is set as “the input image” in FIG. 2. The pixel selection processing unit 20 of the image quality improvement processing apparatus 2 shown in FIG. 4, performs the pixel selection by a method same as “the pixel selection processing” performed in the pixel selection processing unit 20 of the image quality improvement processing apparatus 1 shown in FIG. 1, and then generates “an input image that pixel selection and luminance amendment are performed” by performing the image synthesis (the mask synthesis) based on the binary format image that is the pixel selection result and the input image that luminance amendment is performed.

Finally, like “the image quality improvement processing” by the image quality improvement processing unit 40 of the image quality improvement processing apparatus 1 shown in FIG. 1, based on “the input image that pixel selection and luminance amendment are performed” generated in the pixel selection processing unit 20 of the image quality improvement processing apparatus 2 shown in FIG. 4, the image quality improvement processing unit 40 of the image quality improvement processing apparatus 2 shown in FIG. 4, generates an image with high image quality using an existing method.

FIG. 5 is a block constitution diagram illustrating a third embodiment of an image quality improvement processing apparatus according to the present invention. As shown in FIG. 5, “the image quality improvement processing apparatus” according to the third embodiment of the present invention (hereinafter also simply referred to as “an image quality improvement processing apparatus 3”) comprises a registration processing unit 10, a pixel selection processing unit 20 and an image quality improvement processing unit 40.

As shown in FIG. 5, the image processing by the image quality improvement processing apparatus 3, performs “the pixel selection processing” by the pixel selection processing unit 20 without performing the luminance amendment processing after “the registration processing” by the registration processing unit 10 is performed, and then generates an image with high image quality by performing “the image quality improvement processing” by the image quality improvement processing unit 40 based on “the input image that pixel selection is performed” generated by the pixel selection processing. Incidentally, the input and output of “the pixel selection processing” performed in the pixel selection processing unit 20 of the image quality improvement processing apparatus 3 shown in FIG. 5, are the same as the input and output of “the pixel selection processing” performed in the pixel selection processing unit 20 of the image quality improvement processing apparatus 1 shown in FIG. 1.

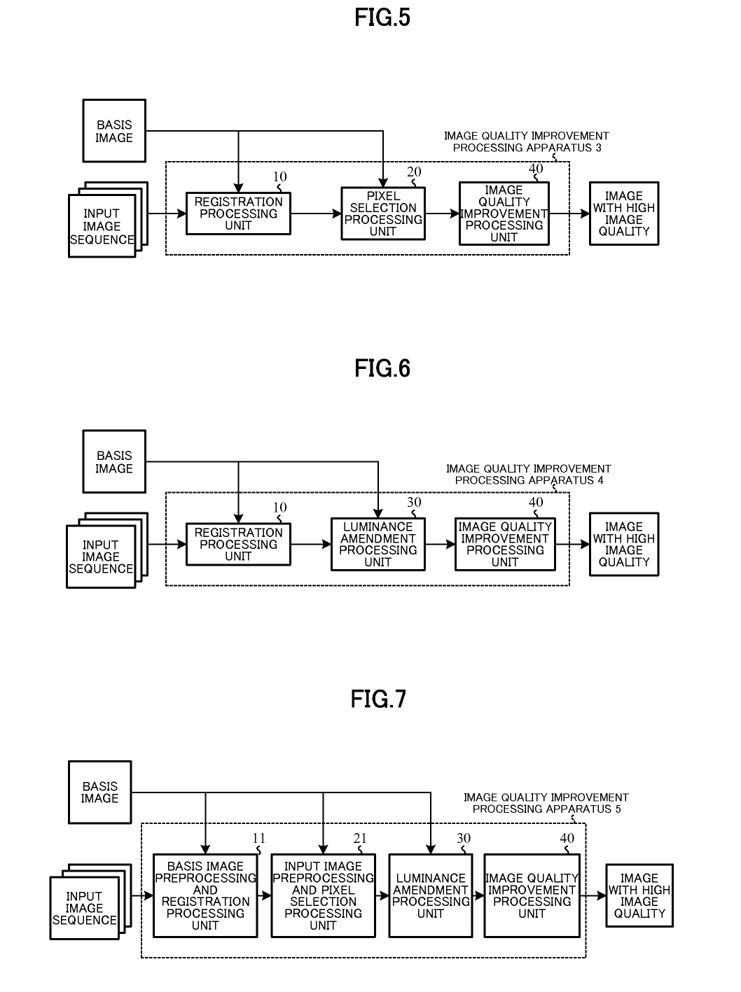

FIG. 6 is a block constitution diagram illustrating a fourth embodiment of an image quality improvement processing apparatus according to the present invention. As shown in FIG. 6, “the image quality improvement processing apparatus” according to the fourth embodiment of the present invention (hereinafter also simply referred to as “an image quality improvement processing apparatus 4”) comprises a registration processing unit 10, a luminance amendment processing unit 30 and an image quality improvement processing unit 40.

As shown in FIG. 6, the image processing by the image quality improvement processing apparatus 4, performs “the luminance amendment processing” by the luminance amendment processing unit 30 without performing the pixel selection processing after “the registration processing” by the registration processing unit 10 is performed, and then generates an image with high image quality by performing “the image quality improvement processing” by the image quality improvement processing unit 40 based on “the input image that luminance amendment is performed” generated by the luminance amendment processing. Incidentally, the input and output of “the luminance amendment processing” performed in the luminance amendment processing unit 30 of the image quality improvement processing apparatus 4 shown in FIG. 6, are the same as the input and output of “the luminance amendment processing” performed in the luminance amendment processing unit 30 of the image quality improvement processing apparatus 2 shown in FIG. 4.

When the above descriptions are summarized, “the image quality improvement processing that uses pixel selection and luminance amendment” according to the present invention, means the image processing by the image quality improvement processing apparatus 1 shown in FIG. 1, or the image processing by the image quality improvement processing apparatus 2 shown in FIG. 4. Further, “the image quality improvement processing that uses pixel selection” according to the present invention, means the image processing by the image quality improvement processing apparatus 3 shown in FIG. 5. Moreover, “the image quality improvement processing that uses luminance amendment” according to the present invention, means the image processing by the image quality improvement processing apparatus 4 shown in FIG. 6.

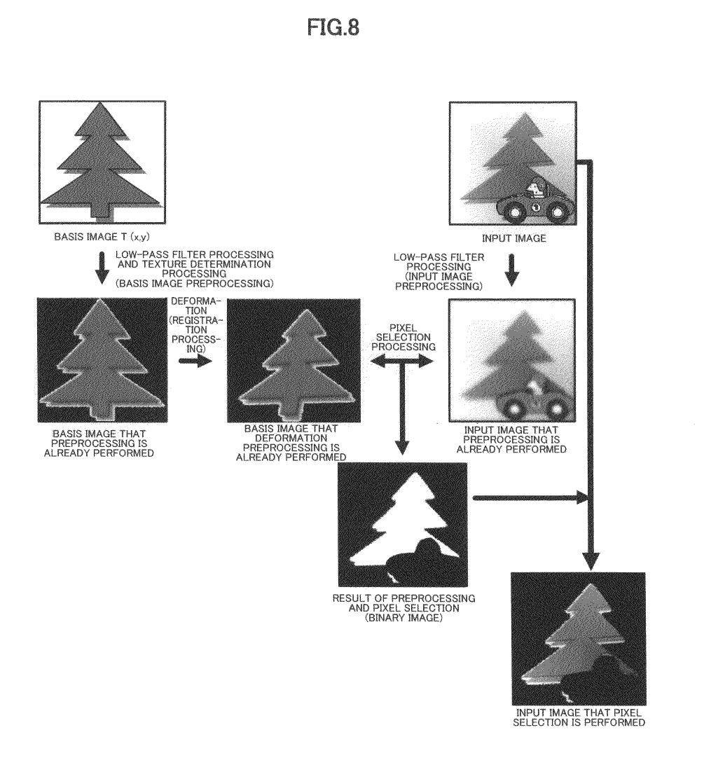

FIG. 7 is a block constitution diagram illustrating a fifth embodiment of an image quality improvement processing apparatus according to the present invention.

As shown in FIG. 7, “the image quality improvement processing apparatus” according to the fifth embodiment of the present invention (hereinafter also simply referred to as “an image quality improvement processing apparatus 5”) comprises a basis image preprocessing and registration processing unit 11, an input image preprocessing and pixel selection processing unit 21, a luminance amendment processing unit 30 and an image quality improvement processing unit 40.

In the image quality improvement processing apparatus 5 of the present invention, at first, based on a basis image that a basis image preprocessing is performed (hereinafter simply referred to as “a basis image that preprocessing is already performed”) and the input images (the input image sequence), the basis image preprocessing and registration processing unit 11 performs “the registration processing” between the basis image that preprocessing is already performed and the input image. Next, the input image preprocessing and pixel selection processing unit 21 performs “the pixel selection processing” that selects pixels suitable for the image quality improvement processing based on the basis image that preprocessing is already performed after the registration processing (hereinafter simply referred to as “a basis image that deformation preprocessing is already performed”), an input image that an input image preprocessing is performed (hereinafter simply referred to as “an input image that preprocessing is already performed”) and the input image. And then, the luminance amendment processing unit 30 performs “the luminance amendment processing” that performs the luminance amendment for pixels of the input image that pixel selection is performed so that luminances of pixels of the said input image become corresponding to luminances of corresponding pixels of the basis image. Finally, the image quality improvement processing unit 40 generates an image with high image quality by performing “the image quality improvement processing” based on pixels that pixel selection and luminance amendment are performed.

Since “the luminance amendment processing” performed in the luminance amendment processing unit 30 of the image quality improvement processing apparatus 5 and “the image quality improvement processing” performed in the image quality improvement processing unit 40 of the image quality improvement processing apparatus 5 are the same as “the luminance amendment processing” performed in the luminance amendment processing unit 30 of the image quality improvement processing apparatus 1 and “the image quality improvement processing” performed in the image quality improvement processing unit 40 of the image quality improvement processing apparatus 1, descriptions of those processing are omitted.

Here, we describe “the registration processing” performed in the basis image preprocessing and registration processing unit 11 of the image quality improvement processing apparatus 5 and “the pixel selection processing” performed in the input image preprocessing and pixel selection processing unit 21 of the image quality improvement processing apparatus 5.

FIG. 8 is a conceptual diagram illustrating “the registration processing” that is performed in the basis image preprocessing and registration processing unit 11 of the present invention and “the pixel selection processing” that is performed in the input image preprocessing and pixel selection processing unit 21 of the present invention.

As shown in FIG. 8, firstly, the basis image preprocessing and registration processing unit 11 generates a basis image that preprocessing is already performed by performing a basis image preprocessing for the basis image T(x,y), and then generates a basis image that deformation preprocessing is already performed by performing a registration processing (a deformation) based on the basis image that preprocessing is already performed and the k-th input image Iₖ(x, y) of the input image sequence (not shown in FIG. 8), that is to say, by deforming the basis image that preprocessing is already performed so that the basis image that preprocessing is already performed comes to correspond to the k-th input image Iₖ(x,y) (the input image).

In other words, the basis image preprocessing and registration processing unit 11 generates (obtains) the basis image that deformation preprocessing is already performed by performing the registration processing between the basis image that preprocessing is already performed and the input image. Incidentally, as described above, the registration processing (the deformation processing) uses an existing method.

However, in the present invention, it is not always true that the deformation of the basis image that preprocessing is already performed for the input image is complete, that is to say, it is not necessarily the case that the registration processing between the basis image that preprocessing is already performed and the input image performed in the basis image preprocessing and registration processing unit 11 is performed precisely, and there is the case that the registration result includes registration errors or occlusions (occlusion regions) exist.

Next, we concretely describe “the pixel selection processing” performed in the input image preprocessing and pixel selection processing unit 21 after the registration processing (the deformation) is performed. “The pixel selection processing” performed in the input image preprocessing and pixel selection processing unit 21 is a processing that selects pixels used in “the image quality improvement processing” performed in the image quality improvement processing unit 40, i.e. pixels suitable for the image quality improvement processing.

Firstly, the input image preprocessing and pixel selection processing unit 21, generates an input image that preprocessing is already performed by performing an input image preprocessing for the input image.

Here, we describe the case of performing the pixel selection processing with respect to a pixel of a certain position (x,y) of the input image (hereinafter also simply referred to as “a pixel of interest) in the input image preprocessing and pixel selection processing unit 21.

That is to say, in the input image preprocessing and pixel selection processing unit 21, with respect to a surrounding small region of a pixel of interest, in the case that the following two conditions are satisfied, the pixel of interest is selected as “a pixel used in the image quality improvement processing”.

### Condition A:

A similarity of a small region of the input image that preprocessing is already performed including the pixel of interest and a corresponding small region of the basis image that deformation preprocessing is already performed, is a predetermined threshold (the first threshold) or more.

### Condition B:

An estimated value of a displacement of the pixel of interest which uses either the small region of the input image that preprocessing is already performed or the corresponding small region of the basis image that deformation preprocessing is already performed, is a predetermined threshold (the second threshold) or less.

The input image preprocessing and pixel selection processing unit 21 generates a binary format image shown in FIG. 8 (a result of preprocessing and pixel selection) that corresponds to the input image by setting the pixel of interest that satisfies the above condition A and condition B as a pixel value 1 and setting the pixel of interest that does not satisfy the above condition A and condition B as a pixel value 0, that is to say, selects pixels used in the image quality improvement processing.

In short, the input image preprocessing and pixel selection processing unit 21 performs the pixel selection by selecting the pixel of interest that satisfies the above condition A and condition B as a pixel used in the image quality improvement processing and removing the pixel of interest that does not satisfy the above condition A and condition B, and then generates “an input image that pixel selection is performed” shown in FIG. 8 by performing an image synthesis (a mask synthesis) based on the binary format image that is the result of preprocessing and pixel selection (pixels with the pixel value 1 means pixels used in the image quality improvement processing and pixels with the pixel value 0 means pixels that are not used in the image quality improvement processing, i.e. pixels that are removed) and the input image (the input image before the input image preprocessing is performed).

That is to say, “the pixel selection processing” performed in the input image preprocessing and pixel selection processing unit 21, is characterized by generating a mask by performing the pixel selection processing based on the input image that the input image preprocessing is performed (the input image that preprocessing is already performed) and the basis image that the basis image preprocessing is performed after the registration processing (the basis image that deformation preprocessing is already performed), and then generating an input image that pixel selection is performed based on the generated mask and the input image (the input image that the input image preprocessing is not performed).

In addition, although FIG. 8 shows a specific example that a low-pass filter processing and a texture determination processing are used as the basis image processing (i.e. a processing flow that performs the texture determination processing after performing the low-pass filter processing is used) and only a low-pass filter processing is used as the input image processing, the present invention is not be limited to that. For example, in the present invention, it is also possible that only a low-pass filter processing is used as the basis image processing and only a low-pass filter processing is also used as the input image processing. Also, it is possible to use the common image processing as the basis image processing and the input image processing.

The texture determination processing selects pixels in the circumference of the pixel of interest of the basis image that textures are a predetermined threshold or more by determining textures for every small region of the circumference of the pixel of interest of the basis image, and then generates a binary mask using the selected pixels. In the texture determination processing, it is possible to use various methods such as a method that the variance of pixel values within the small region is a threshold or more.

As a specific example of the texture determination processing, with respect to a pixel correspond to a certain two-dimensional image coordinate (x,y), the texture determination processing is performed by selecting the pixel in the case that a value f(x) of the following Expression 1 is a predetermined threshold or more.

$$f ( x ) = {\sum }_{y ∈ S ( x )} c ( I ( x ) , I ( y ) ) \\ c ( I ( x ) , I ( y ) ) = \{ \begin{matrix}0 , & d ( I ( x ) , I ( y ) ) \leq t \\ 1 , & d ( I ( x ) , I ( y ) ) > t\end{matrix} \qquad [ Expression 1 ]$$

Where x,y represent the two-dimensional image coordinate. S(x) represents a set of image coordinates of the circumference of the image coordinate x. I(x) represents the pixel value information of the image coordinate x. I(y) represents the pixel value information of the image coordinate y. d(I(x),I(y)) represents a distance function between the pixel value information I(x) and I(y). t represents a threshold for a distance of the pixel value information. As the distance function, it is possible to use the Euclidean distance function.

Incidentally, in the basis image that preprocessing is already performed and the basis image that deformation preprocessing is already performed of FIG. 8, pixels indicated by black, represent pixels that are determined that textures are small by the texture determination processing (i.e. pixels that are not selected by the texture determination processing).

In addition, although the generated mask by the texture determination processing described above is a binary mask, the texture determination processing of the present invention is not limited to that. In the texture determination processing of the present invention, it is possible to generate a multi-value mask, and for example it is possible to set a multi-value mask so that the stronger the texture the larger the value of the multi-value mask becomes.

In the image quality improvement processing, it is possible to use the multi-value mask of the pixel of interest as an index of the degree of importance (the weight) of the pixel of interest.

Further, in the present invention, it is also possible to omit the luminance amendment processing unit 30 (the luminance amendment processing by the luminance amendment processing unit 30) in the image quality improvement processing apparatus 5 shown in FIG. 7.

Moreover, like the pixel selection processing unit 20, in the input image preprocessing and pixel selection processing unit 21, it is possible to perform the pixel selection by using a binary mask as described above, and it is also possible to perform the pixel selection by using a multi-value mask (a weight).

Furthermore, in the embodiment of “the input image preprocessing and pixel selection processing unit 21” of the present invention described above, although satisfying the above condition A and condition B is set as the condition of the pixel selection, “the input image preprocessing and pixel selection processing unit 21” of the present invention is not be limited to that. In “the input image preprocessing and pixel selection processing unit 21” of the present invention, it is also possible to select the pixel of interest that satisfies only the above condition A or the pixel of interest that satisfies only the above condition B as the pixel used in the image quality improvement processing.

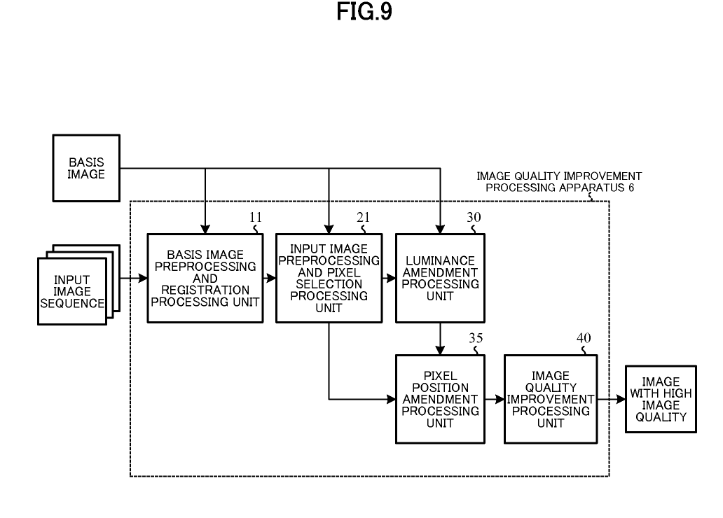

FIG. 9 is a block constitution diagram illustrating a sixth embodiment of an image quality improvement processing apparatus according to the present invention.

As shown in FIG. 9, “the image quality improvement processing apparatus” according to the sixth embodiment of the present invention (hereinafter also simply referred to as “an image quality improvement processing apparatus 6”) comprises a basis image preprocessing and registration processing unit 11, an input image preprocessing and pixel selection processing unit 21, a luminance amendment processing unit 30, a pixel position amendment processing unit 35 and an image quality improvement processing unit 40.

By comparing FIG. 9 with FIG. 7, it is clear that the image quality improvement processing apparatus 6 shown in FIG. 9 is obtained by adding “the pixel position amendment processing unit 35” to the image quality improvement processing apparatus 5 shown in FIG. 7.

Since the flow and the content of the image processing by the image quality improvement processing apparatus 6 are basically the same as the flow and the content of the image processing by the image quality improvement processing apparatus 5, descriptions of those are omitted. Here, we describe “the pixel position amendment processing unit 35” of the image quality improvement processing apparatus 6 that performs “the pixel position amendment processing”.

“The pixel position amendment processing unit 35” of the image quality improvement processing apparatus 6, performs “the pixel position amendment processing” so as to amend the position of each pixel of the input image that pixel selection and luminance amendment are performed from the luminance amendment processing unit 30 based on the estimated value of the displacement for every pixel that is estimated in the input image preprocessing and pixel selection processing unit 21.

And then, “the image quality improvement processing unit 40” of the image quality improvement processing apparatus 6, generates an image with high image quality by performing “the image quality improvement processing” based on each pixel of the input image that pixel selection and luminance amendment are performed after the pixel position amendment processing from “the pixel position amendment processing unit 35”.

In addition, with respect to the image quality improvement processing apparatus 6 shown in FIG. 9, it is possible to interchange the connecting order of the pixel position amendment processing unit 35 and the luminance amendment processing unit 30, or it is also possible to omit the luminance amendment processing unit 30. Further, with respect to the image quality improvement processing apparatus 6 shown in FIG. 9, it is also possible to use “the pixel selection processing unit 20” of FIG. 1 as a substitute for “the input image preprocessing and pixel selection processing unit 21”.

That is to say, in the present invention, since the displacement for every small region is re-estimated by the pixel selection processing performed in “the pixel selection processing unit 20” or “the input image preprocessing and pixel selection processing unit 21”, and so “the pixel position amendment processing unit 35” performs the pixel position amendment processing by amending the pixel position of the pixel of interest based on the re-estimated displacement.

It is possible to implement the image quality improvement processing apparatus according to the present invention described above by using a computer system and a software (a computer program) recorded in a computer-readable medium. And then, of course it is also possible to implement the image quality improvement processing apparatus according to the present invention described above by hardwares such as an ASIC (Application Specific Integrated Circuit), a GPU (Graphics Processing Unit) and an FPGA (Field Programmable Gate Array).

In order to verify effects of the present invention, the following embodiment is carried out.

By using a digital camera having a Bayer color filter, 30 images are captured. And the captured all images are full-colorized. That is to say, in the case of applying the present invention, an input image sequence consisting of the full-colorized images (hereinafter also referred to as “the observed images”) of 30 frames, exists. Further, in this embodiment, the super-resolution processing (the high-resolution-ization processing) is used as the image quality improvement processing.

After setting the image of the initial frame (the first frame) of this input image sequence as the basis image and setting images from the second frame to the 30th frame as the input images except the basis image, the image processing is performed by using “the image quality improvement processing apparatus according to the first embodiment of the present invention”, and the image with high image quality is generated.

In the registration processing between the basis image and the input image, the density gradient method is used for the whole image. Further, in the pixel selection processing, the size of the surrounding small region of the pixel of interest is set to 15[pixel]×15[pixel]. In the similarity in the above condition 1, the normalized cross correlation is used and the predetermined threshold (the first threshold) is set to 0.99. Moreover, in the estimation of the displacement in the above condition 2, the size of the small region is set to 15[pixel]×15[pixel], the sub-pixel estimation based on a parabola fitting that the normalized cross correlation is used in the similarity is performed, and the threshold of the displacement (the second threshold) is set to 0.5.

Furthermore, for a binary format image that is obtained by setting pixel values of pixels selected by the above conditions to 1 and setting pixel values of pixels that are not selected to 0, an average filtering with the size of 9[pixel]×9[pixel] is performed, a binarizing processing that the threshold is set to 0.2 is performed, and a final pixel selection result is obtained. That is to say, this final pixel selection result is set as the mask image, and then the input image that pixel selection is performed is generated by performing an image synthesis (a mask synthesis) based on the mask image and the input image.

In the luminance amendment processing, with respect to each pixel of the generated “the input image that pixel selection is performed” and “the basis image that registration processing is already performed”, luminances of the six-sided pyramid model are computed, luminances are estimated by performing an average filtering with the size of 5[pixel]×5[pixel] for the obtained luminance images (the first luminance image and the second luminance image). The pixels of “the input image that pixel selection is performed” are amended so that the estimated luminance of each pixel of “the input image that pixel selection is performed” corresponds to the luminance of the corresponding pixel of “the basis image that registration processing is already performed”. By such a luminance amendment processing, “the input image that pixel selection and luminance amendment are performed” is generated.

Based on the generated “the input image that pixel selection and luminance amendment are performed”, that is to say, by using pixels that are pixel-selected from the input image (the observed image) and then are luminance-amended, the high-resolution-ization processing is performed. The high-resolution-ization processing used an existing method and set the magnification to 4×4.

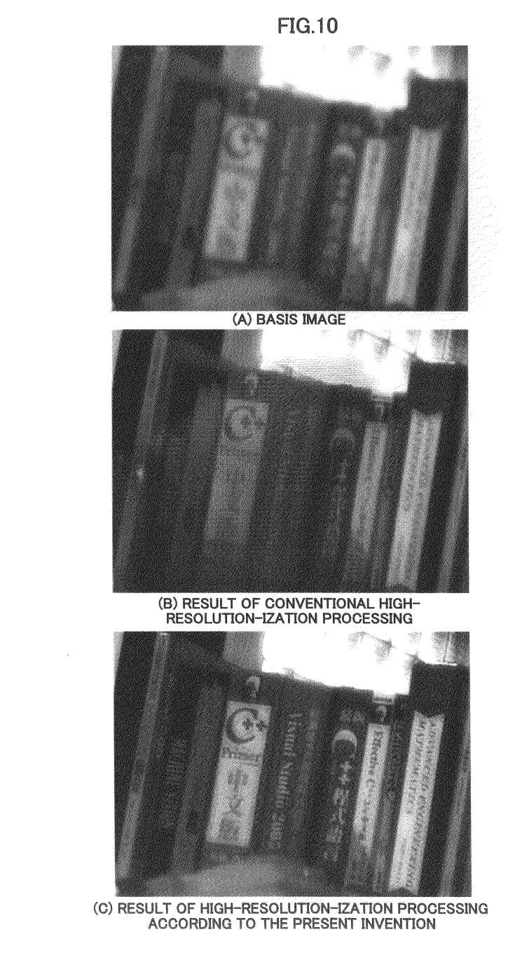

FIG. 10(A) shows an image that is selected as the basis image from the observed images. FIG. 10(B) shows the high-resolution-ization processing result based on a conventional super-resolution processing method that does not use the pixel selection and the luminance amendment. FIG. 10(C) shows the high-resolution-ization processing result based on “the image quality improvement processing that uses the pixel selection and the luminance amendment” according to the present invention shown in FIG. 1.

From FIG. 10, it is confirmed that in the case of using a conventional method, the high-resolution-ization is not performed accurately due to influences of occlusions, on the other hand, in the case of using the image quality improvement processing apparatus (the image quality improvement processing method) according to the present invention, the high-resolution-ization without influences of occlusions is performed.

### INDUSTRIAL APPLICABILITY

The present invention has the most distinguished technical characteristic that after determining regions that the registration is inaccurate (i.e. regions that the registration error is large) and occlusion regions, and removing these relevant regions, “the pixel selection processing” that selects pixels suitable for the image quality improvement processing and/or “the luminance amendment processing” that performs the luminance amendment for the pixel-selected pixels so that luminances of the pixel-selected pixels of the input image become equal to luminances of corresponding pixels of the basis image, are performed.

According to the present invention having such a technical characteristic, an excellent effect that since the image quality improvement processing is performed by using the selected pixels as pixels suitable for the image quality improvement processing, even in the case that the registration processing is not performed so precisely, unnatural noises do not occur in the result of the image quality improvement processing, and an image with a desired high image quality can be obtained, is played.

That is to say, since the method used in “the pixel selection processing” of the present invention is highly robust to registration errors, and so the utility in the practical use is extremely big. For example, by applying the present invention, an application of “performing the image quality improvement processing by using the displacement information embedded beforehand in a moving image such as an MPEG (Moving Picture Experts Group) video”, is expected highly. As the image quality improvement processing, for example, there are the high-resolution-ization processing and the noise reduction processing.

Moreover, in the case that occlusions occur, the shadow of the occluded object occurs mostly in the target region. However, since the method used in “the pixel selection processing” of the present invention is also a pixel selection method robust to luminance variations due to shadows, by amending luminances of the pixel-selected pixels after the pixel selection processing and performing the image quality improvement processing based on the pixel-selected and luminance-amended pixels, it is possible to perform the image quality improvement processing by also using regions that the luminance varies with the shadow and obtain an image with high image quality.

### THE LIST OF REFERENCES

### Non-Patent Document 1:

W. Zhao and H. S. Sawhney, “Is Super-Resolution with Optical Flow Feasible?”, Proc. Euro. Conf. Computer Vision Lecture Notes in Computer Science: Springer-Verlag, Vol. 2350, p. 599-613, 2002.

### Non-Patent Document 2:

Z. A. Ivanovski, L. Panovski and L. J. Karam, “Robust super-resolution based on pixel-level selectivity”, Visual Communications and Image Processing 2006, Proc. of SPIE-IS&T Electronic Imaging, SPIE Vol. 6077, 2006.

### Non-Patent Document 3:

M. Toda, M. Tsukada and A. Inoue, “Super-Resolution Considering Registration Error”, Proc. FIT 2006, p. 63-64, 2006.

### Non-Patent Document 4:

S. K. Chang, M. Shimizu and M. Okutomi, “Region-Selective Two-Step Image Registration”, MIRU2006, p. 229-234, July 2006.

### Non-Patent Document 5:

M. Okutomi, et al., “Digital Image Processing”, Computer Graphic Arts Society, 2004.

What is claimed is:

1. An image quality improvement processing apparatus for generating an image with high image quality based on a basis image and one or more input images, said apparatus characterized by comprising:
a registration processing unit for generating a basis image that registration processing is already performed by performing a registration processing between said basis image and said input image;
a pixel selection processing unit for
selecting pixels used in an image quality improvement processing based on said basis image that registration processing is already performed generated in said registration processing unit and said input image by a predetermined condition, and
generating an input image that pixel selection is performed by performing an image synthesis based on a pixel selection result and said input image;
a luminance amendment processing unit for generating an input image that pixel selection and luminance amendment are performed by amending pixel values of said input image that pixel selection is performed so that luminances of pixels of said input image that pixel selection is performed generated in said pixel selection processing unit become equal to luminances of corresponding pixels of said basis image that registration processing is already performed; and
an image quality improvement processing unit for generating said image with high image quality by performing said image quality improvement processing based on said input image that pixel selection and luminance amendment are performed generated in said luminance amendment processing unit.

2. An image quality improvement processing apparatus for generating an image with high image quality based on a basis image and one or more input images, said apparatus characterized by comprising:
a registration processing unit for generating a basis image that registration processing is already performed by performing a registration processing between said basis image and said input image;
a pixel selection processing unit for
selecting pixels used in an image quality improvement processing based on said basis image that registration processing is already performed generated in said registration processing unit and said input image by a predetermined condition, and
generating an input image that pixel selection is performed by performing an image synthesis based on a pixel selection result and said input image; and
an image quality improvement processing unit for generating said image with high image quality by performing said image quality improvement processing based on said input image that pixel selection is performed generated in said pixel selection processing unit.

3. The image quality improvement processing apparatus according to claim 1, wherein
a first condition is that a similarity of a small region of said input image including a pixel of interest and a corresponding small region of said basis image that registration processing is already performed is a first threshold or more,
a second condition is that an estimated value of a displacement of said pixel of interest which uses either said small region of said input image or said corresponding small region of said basis image that registration processing is already performed, is a second threshold or less,
said predetermined condition is said second condition, or said first condition and said second condition,
said pixel selection processing unit performs the pixel selection by selecting said pixel of interest which satisfies said predetermined condition as a pixel used in said image quality improvement processing and removing said pixel of interest which does not satisfy said predetermined condition.

4. The image quality improvement processing apparatus according to claim 3, wherein
said similarity in said first condition is a similarity that uses a normalized cross correlation of corresponding small regions and does not depend on luminance variations,
said estimated value of said displacement in said second condition is estimated by a displacement estimating method that uses a parabola fitting of a normalized cross correlation which assumed a translation and does not depend on luminance variations.

5. The image quality improvement processing apparatus according to claim 1, wherein
said pixel selection result is a binary format image,
for said binary format image, a low-pass filtering is performed and a binarizing processing using a proper threshold is performed.

6. An image quality improvement processing apparatus for generating an image with high image quality based on a basis image and one or more input images, said apparatus characterized by comprising:
a registration processing unit for generating a basis image that registration processing is already performed by performing a registration processing between said basis image and said input image;
a luminance amendment processing unit for generating an input image that luminance amendment is performed by amending pixel values of said input image so that luminances of pixels of said input image become equal to luminances of corresponding pixels of said basis image that registration processing is already performed;
a pixel selection processing unit for
selecting pixels used in an image quality improvement processing based on said input image that luminance amendment is performed and said basis image that registration processing is already performed by a predetermined condition, and
generating an input image that pixel selection and luminance amendment are performed by performing an image synthesis based on a pixel selection result and said input image that luminance amendment is performed; and
an image quality improvement processing unit for generating said image with high image quality by performing said image quality improvement processing based on said input image that pixel selection and luminance amendment are performed generated in said pixel selection processing unit.

7. The image quality improvement processing apparatus according to claim 6, wherein
a first condition is that a similarity of a small region of said input image that luminance amendment is performed including a pixel of interest and a corresponding small region of said basis image that registration processing is already performed is a first threshold or more,
a second condition is that an estimated value of a displacement of said pixel of interest which uses either said small region of said input image that luminance amendment is performed or said corresponding small region of said basis image that registration processing is already performed, is a second threshold or less,
said predetermined condition is said second condition, or said first condition and said second condition,
said pixel selection processing unit performs the pixel selection by selecting said pixel of interest which satisfies said predetermined condition as a pixel used in said image quality improvement processing and removing said pixel of interest which does not satisfy said predetermined condition.

8. The image quality improvement processing apparatus according to claim 7, wherein
said similarity in said first condition is a similarity that uses a normalized cross correlation of corresponding small regions and does not depend on luminance variations,
said estimated value of said displacement in said second condition is estimated by a displacement estimating method that uses a parabola fitting of a normalized cross correlation which assumed a translation and does not depend on luminance variations.

9. The image quality improvement processing apparatus according to claim 6, wherein
said pixel selection result is a binary format image,
for said binary format image, a low-pass filtering is performed and a binarizing processing using a proper threshold is performed.

10. An image quality improvement processing apparatus for generating an image with high image quality based on a basis image and one or more input images, said apparatus characterized by comprising:
a registration processing unit for generating a basis image that registration processing is already performed by performing a registration processing between said basis image and said input image;
a luminance amendment processing unit for generating an input image that luminance amendment is performed by amending pixel values of said input image so that luminances of pixels of said input image become equal to luminances of corresponding pixels of said basis image that registration processing is already performed; and
an image quality improvement processing unit for generating said image with high image quality by performing an image quality improvement processing based on said input image that luminance amendment is performed generated in said luminance amendment processing unit.

11. An image quality improvement processing method for generating an image with high image quality based on a basis image and one or more input images, said method characterized by comprising:
a registration processing step for generating a basis image that registration processing is already performed by performing a registration processing between said basis image and said input image;
a pixel selection processing step for
selecting pixels used in an image quality improvement processing based on said basis image that registration processing is already performed generated in said registration processing step and said input image by a predetermined condition, and
generating an input image that pixel selection is performed by performing an image synthesis based on a pixel selection result and said input image;
a luminance amendment processing step for generating an input image that pixel selection and luminance amendment are performed by amending pixel values of said input image that pixel selection is performed so that luminances of pixels of said input image that pixel selection is performed generated in said pixel selection processing step become equal to luminances of corresponding pixels of said basis image that registration processing is already performed; and
an image quality improvement processing step for generating said image with high image quality by performing said image quality improvement processing based on said input image that pixel selection and luminance amendment are performed generated in said luminance amendment processing step.

12. An image quality improvement processing method for generating an image with high image quality based on a basis image and one or more input images, said method characterized by comprising:
a registration processing step for generating a basis image that registration processing is already performed by performing a registration processing between said basis image and said input image;
a pixel selection processing step for
selecting pixels used in an image quality improvement processing based on said basis image that registration processing is already performed generated in said registration processing step and said input image by a predetermined condition, and
generating an input image that pixel selection is performed by performing an image synthesis based on a pixel selection result and said input image; and
an image quality improvement processing step for generating said image with high image quality by performing said image quality improvement processing based on said input image that pixel selection is performed generated in said pixel selection processing step.

13. An image quality improvement processing method for generating an image with high image quality based on a basis image and one or more input images, said method characterized by comprising:
a registration processing step for generating a basis image that registration processing is already performed by performing a registration processing between said basis image and said input image;
a luminance amendment processing step for generating an input image that luminance amendment is performed by amending pixel values of said input image so that luminances of pixels of said input image become equal to luminances of corresponding pixels of said basis image that registration processing is already performed;
a pixel selection processing step for
selecting pixels used in an image quality improvement processing based on said input image that luminance amendment is performed and said basis image that registration processing is already performed by a predetermined condition, and
generating an input image that pixel selection and luminance amendment are performed by performing an image synthesis based on a pixel selection result and said input image that luminance amendment is performed; and
an image quality improvement processing step for generating said image with high image quality by performing said image quality improvement processing based on said input image that pixel selection and luminance amendment are performed generated in said pixel selection processing step.

14. An image quality improvement processing method for generating an image with high image quality based on a basis image and one or more input images, said method characterized by comprising:
a registration processing step for generating a basis image that registration processing is already performed by performing a registration processing between said basis image and said input image;
a luminance amendment processing step for generating an input image that luminance amendment is performed by amending pixel values of said input image so that luminances of pixels of said input image become equal to luminances of corresponding pixels of said basis image that registration processing is already performed; and
an image quality improvement processing step for generating said image with high image quality by performing an image quality improvement processing based on said input image that luminance amendment is performed generated in said luminance amendment processing step.

15. A computer-readable recording medium storing an image quality improvement processing computer program which generates an image with high image quality based on a basis image and one or more input images, said image quality improvement processing computer program is executable with a computer, comprising:
a step (A1) for generating a basis image that registration processing is already performed by performing a registration processing between said basis image and said input image;
a step (A2) for
selecting pixels used in an image quality improvement processing based on said basis image that registration processing is already performed generated in said step (A1) and said input image by a predetermined condition, and
generating an input image that pixel selection is performed by performing an image synthesis based on a pixel selection result and said input image;
a step (A3) for generating an input image that pixel selection and luminance amendment are performed by amending pixel values of said input image that pixel selection is performed so that luminances of pixels of said input image that pixel selection is performed generated in said step (A2) become equal to luminances of corresponding pixels of said basis image that registration processing is already performed; and
a step (A4) for generating said image with high image quality by performing said image quality improvement processing based on said input image that pixel selection and luminance amendment are performed generated in said step (A3).

16. A computer-readable recording medium storing an image quality improvement processing computer program which generates an image with high image quality based on a basis image and one or more input images, said image quality improvement processing computer program is executable with a computer, comprising:
a step (B1) for generating a basis image that registration processing is already performed by performing a registration processing between said basis image and said input image;
a step (B2) for
selecting pixels used in an image quality improvement processing based on said basis image that registration processing is already performed generated in said step (B1) and said input image by a predetermined condition, and
generating an input image that pixel selection is performed by performing an image synthesis based on a pixel selection result and said input image; and
a step (B3) for generating said image with high image quality by performing said image quality improvement processing based on said input image that pixel selection is performed generated in said step (B2).

17. A computer-readable recording medium storing an image quality improvement processing computer program which generates an image with high image quality based on a basis image and one or more input images, said image quality improvement processing computer program is executable with a computer, comprising:
a step (C1) for generating a basis image that registration processing is already performed by performing a registration processing between said basis image and said input image;
a step (C2) for generating an input image that luminance amendment is performed by amending pixel values of said input image so that luminances of pixels of said input image become equal to luminances of corresponding pixels of said basis image that registration processing is already performed;
a step (C3) for
selecting pixels used in an image quality improvement processing based on said input image that luminance amendment is performed and said basis image that registration processing is already performed by a predetermined condition, and
generating an input image that pixel selection and luminance amendment are performed by performing an image synthesis based on a pixel selection result and said input image that luminance amendment is performed; and
a step (C4) for generating said image with high image quality by performing said image quality improvement processing based on said input image that pixel selection and luminance amendment are performed generated in said step (C3).

18. A computer-readable recording medium storing an image quality improvement processing computer program which generates an image with high image quality based on a basis image and one or more input images, said image quality improvement processing computer program is executable with a computer, comprising:
a step (D1) for generating a basis image that registration processing is already performed by performing a registration processing between said basis image and said input image;
a step (D2) for generating an input image that luminance amendment is performed by amending pixel values of said input image so that luminances of pixels of said input image become equal to luminances of corresponding pixels of said basis image that registration processing is already performed; and
a step (D3) for generating said image with high image quality by performing an image quality improvement processing based on said input image that luminance amendment is performed generated in said step (D2).

19. An image quality improvement processing apparatus for generating an image with high image quality based on a basis image and one or more input images, said apparatus characterized by comprising:
a basis image preprocessing and registration processing unit for generating a basis image that deformation preprocessing is already performed by performing a registration processing between a basis image that preprocessing is already performed obtained by performing a basis image preprocessing for said basis image and said input image;
an input image preprocessing and pixel selection processing unit for
selecting pixels used in an image quality improvement processing based on said basis image that deformation preprocessing is already performed and an input image that preprocessing is already performed obtained by performing an input image preprocessing for said input image by a predetermined condition, and
generating an input image that pixel selection is performed by performing an image synthesis based on a pixel selection result and said input image;
a luminance amendment processing unit for generating an input image that pixel selection and luminance amendment are performed by amending pixel values of said input image that pixel selection is performed so that luminances of pixels of said input image that pixel selection is performed become equal to luminances of corresponding pixels of said basis image that deformation preprocessing is already performed; and
an image quality improvement processing unit for generating said image with high image quality by performing said image quality improvement processing based on said input image that pixel selection and luminance amendment are performed.

20. An image quality improvement processing apparatus for generating an image with high image quality based on a basis image and one or more input images, said apparatus characterized by comprising:
a basis image preprocessing and registration processing unit for generating a basis image that deformation preprocessing is already performed by performing a registration processing between a basis image that preprocessing is already performed obtained by performing a basis image preprocessing for said basis image and said input image;
an input image preprocessing and pixel selection processing unit for
selecting pixels used in an image quality improvement processing based on said basis image that deformation preprocessing is already performed and an input image that preprocessing is already performed obtained by performing an input image preprocessing for said input image by a predetermined condition, and
generating an input image that pixel selection is performed by performing an image synthesis based on a pixel selection result and said input image;
a luminance amendment processing unit for generating an input image that pixel selection and luminance amendment are performed by amending pixel values of said input image that pixel selection is performed so that luminances of pixels of said input image that pixel selection is performed become equal to luminances of corresponding pixels of said basis image that deformation preprocessing is already performed;
a pixel position amendment processing unit for amending the position of each pixel of said input image that pixel selection and luminance amendment are performed generated in said luminance amendment processing unit based on the estimated value of the displacement estimated for every pixel in said input image preprocessing and pixel selection processing unit; and
an image quality improvement processing unit for generating said image with high image quality by performing said image quality improvement processing based on each pixel of said input image that pixel selection and luminance amendment are performed that the pixel position amendment is already performed from said pixel position amendment processing unit.

21. The image quality improvement processing apparatus according to claim 19, wherein
a condition A is that a similarity of a small region of said input image that preprocessing is already performed including a pixel of interest and a corresponding small region of said basis image that deformation preprocessing is already performed is a first threshold or more,
a condition B is that an estimated value of a displacement of said pixel of interest which uses either said small region of said input image that preprocessing is already performed or said corresponding small region of said basis image that deformation preprocessing is already performed, is a second threshold or less,
said predetermined condition is said condition B, or said condition A and said condition B,
said input image preprocessing and pixel selection processing unit performs the pixel selection by selecting said pixel of interest which satisfies said predetermined condition as a pixel used in said image quality improvement processing and removing said pixel of interest which does not satisfy said predetermined condition.

22. The image quality improvement processing apparatus according to claim 21, wherein
said similarity in said condition A is a similarity that uses a normalized cross correlation of corresponding small regions and does not depend on luminance variations,
said estimated value of said displacement in said condition B is estimated by a displacement estimating method that uses a parabola fitting of a normalized cross correlation which assumed a translation and does not depend on luminance variations.

23. The image quality improvement processing apparatus according to claim 19, wherein
a low-pass filter processing and a texture determination processing are used as said basis image preprocessing and a low-pass filter processing is used as said input image preprocessing.

24. The image quality improvement processing apparatus according to claim 23, wherein
said texture determination processing
selects pixels in the circumference of the pixel of interest of said basis image that textures are a predetermined threshold or more by determining textures for every small region of the circumference of the pixel of interest of said basis image, and
generates a binary mask using the selected pixels.

25. The image quality improvement processing apparatus according to claim 23, wherein
with respect to a pixel correspond to a certain two-dimensional image coordinate (x,y), said texture determination processing performs the texture determination processing by selecting said pixel in the case that a value f(x) of the following expression is a predetermined threshold or more,
$$f ( x ) = {\sum }_{y ∈ S ( x )} c ( I ( x ) , I ( y ) )$$
$$c ( I ( x ) , I ( y ) ) = \{ \begin{matrix}0 , & d ( I ( x ) , I ( y ) ) \leq t \\ 1 , & d ( I ( x ) , I ( y ) ) > t\end{matrix}$$
where x,y represent the two-dimensional image coordinate, S(x) represents a set of image coordinates of the circumference of the image coordinate x, I(x) represents the pixel value information of the image coordinate x, I(y) represents the pixel value information of the image coordinate y, d(I(x),I(y)) represents a distance function between the pixel value information I(x) and I(y), t represents a threshold for a distance of the pixel value information.

26. An image quality improvement processing method for generating an image with high image quality based on a basis image and one or more input images, said method characterized by comprising:
a basis image preprocessing and registration processing step for generating a basis image that deformation preprocessing is already performed by performing a registration processing between a basis image that preprocessing is already performed obtained by performing a basis image preprocessing for said basis image and said input image;
an input image preprocessing and pixel selection processing step for
selecting pixels used in an image quality improvement processing based on said basis image that deformation preprocessing is already performed and an input image that preprocessing is already performed obtained by performing an input image preprocessing for said input image by a predetermined condition, and
generating an input image that pixel selection is performed by performing an image synthesis based on a pixel selection result and said input image;
a luminance amendment processing step for generating an input image that pixel selection and luminance amendment are performed by amending pixel values of said input image that pixel selection is performed so that luminances of pixels of said input image that pixel selection is performed become equal to luminances of corresponding pixels of said basis image that deformation preprocessing is already performed; and
an image quality improvement processing step for generating said image with high image quality by performing said image quality improvement processing based on said input image that pixel selection and luminance amendment are performed.

27. An image quality improvement processing method for generating an image with high image quality based on a basis image and one or more input images, said method characterized by comprising:
a basis image preprocessing and registration processing step for generating a basis image that deformation preprocessing is already performed by performing a registration processing between a basis image that preprocessing is already performed obtained by performing a basis image preprocessing for said basis image and said input image;
an input image preprocessing and pixel selection processing step for
selecting pixels used in an image quality improvement processing based on said basis image that deformation preprocessing is already performed and an input image that preprocessing is already performed obtained by performing an input image preprocessing for said input image by a predetermined condition, and
generating an input image that pixel selection is performed by performing an image synthesis based on a pixel selection result and said input image;
a luminance amendment processing step for generating an input image that pixel selection and luminance amendment are performed by amending pixel values of said input image that pixel selection is performed so that luminances of pixels of said input image that pixel selection is performed become equal to luminances of corresponding pixels of said basis image that deformation preprocessing is already performed;
a pixel position amendment processing step for amending the position of each pixel of said input image that pixel selection and luminance amendment are performed generated in said luminance amendment processing step based on the estimated value of the displacement estimated for every pixel in said input image preprocessing and pixel selection processing step; and
an image quality improvement processing step for generating said image with high image quality by performing said image quality improvement processing based on each pixel of said input image that pixel selection and luminance amendment are performed that the pixel position amendment is already performed from said pixel position amendment processing step.

28. An image quality improvement processing apparatus characterized in that
based on
an input image, and
the estimated value of the displacement of each corresponding pixel of a basis image registered to said input image, or a similarity and said estimated value of said displacement,
a pixel selection processing to select said pixels is performed,
then an image quality improvement processing is performed by using said selected pixels.

29. An image quality improvement processing apparatus characterized in that
pixel values of an input image are amended so that luminances of pixels of said input image correspond to luminances of pixels of a corresponding basis image,
then an image quality improvement processing is performed by using said pixels that luminance amendment is performed.

30. An image quality improvement processing apparatus characterized in that
firstly, based on
an input image, and
the estimated value of the displacement of each corresponding pixel of a basis image registered to said input image that is not influenced by luminance variations, or a similarity that is not influenced by luminance variations and said estimated value of said displacement,
a pixel selection processing to select said pixels is performed,
secondly, pixel values of said selected pixels are amended so that luminances of said selected pixels correspond to luminances of corresponding pixels of said basis image,
finally, an image quality improvement processing is performed by using said selected pixels that luminance amendment is performed.

31. The image quality improvement processing apparatus according to claim 28 wherein
for a binary format image that is a pixel selection result obtained by said pixel selection processing, a low-pass filtering is performed and a binarizing processing using a proper threshold is performed.

32. The image quality improvement processing apparatus according to claim 28 wherein
said similarity is a similarity that uses a normalized cross correlation of corresponding small regions.

33. The image quality improvement processing apparatus according to claim 28 wherein
said estimated value of said displacement is estimated by a displacement estimating method that uses a parabola fitting of a normalized cross correlation which assumed a translation.

34. An image quality improvement processing method characterized in that
based on
an input image, and
the estimated value of the displacement of each corresponding pixel of a basis image registered to said input image, or a similarity and said estimated value of said displacement,
a pixel selection processing to select said pixels is performed,
then an image quality improvement processing is performed by using said selected pixels.

35. An image quality improvement processing method characterized in that
pixel values of an input image are amended so that luminances of pixels of said input image correspond to luminances of pixels of a corresponding basis image,
then an image quality improvement processing is performed by using said pixels that luminance amendment is performed.

36. An image quality improvement processing method characterized in that
firstly, based on
an input image, and
the estimated value of the displacement of each corresponding pixel of a basis image registered to said input image that is not influenced by luminance variations, or a similarity that is not influenced by luminance variations and said estimated value of said displacement,
a pixel selection processing to select said pixels is performed,
secondly, pixel values of said selected pixels are amended so that luminances of said selected pixels correspond to luminances of corresponding pixels of said basis image,
finally, an image quality improvement processing is performed by using said selected pixels that luminance amendment is performed.
